(19) United States
(12) Patent Application Publication
(10) Pub. No.: US 2026/0140509 A1
(43) Pub. Date: May 21, 2026

(54) APPARATUS AND METHOD FOR PREDICTING ROBOT DELIVERY TIME AND ROBOT DELIVERY PATH BASED ON CROWD ESTIMATION

(71) Applicants: Hyundai Motor Company, Seoul (KR); Kia Corporation, Seoul (KR); SUNGSHIN WOMEN'S UNIVERSITY R&DB FOUNDATION, Seoul (KR)

(72) Inventors: Won Hee Kim, Hwaseong-si (KR); Soomin Shim, Hwaseong-si (KR); Jaehoon You, Hwaseong-si (KR); Seong Wook Hwang, Seoul (KR); Joon Young Kim, Seoul (KR); Namgyo Kim, Gangwon-do (KR); Yujin Song, Dongducheon-si (KR); Hyo Jin Song, Incheon (KR); Sihyeon Park, Chungju-si (KR); Jeong Min Oh, Seoul (KR)

(21) Appl. No.: 19/217,768

(22) Filed: May 23, 2025

(30) Foreign Application Priority Data
Nov. 15, 2024 (KR) 10-2024-0163044

(51) Int. Cl. G05D 1/644; G05D 105/28; G05D 107/60

(52) U.S. Cl. CPC G05D 1/644; G05D 2105/28; G05D 2107/60

(57) ABSTRACT

In an embodiment, a method may include setting a plurality of paths to reach a destination, collecting crowd estimation information of the plurality of paths through sensors on the plurality of paths, calculating a traffic and a latency for each of the plurality of paths based on the crowd estimation information, predicting the delivery time to the destination based on the traffic and the latency with respect to each of the plurality of paths, and determining the delivery path as a path of a shortest delivery time among the plurality of paths.

### CROSS-REFERENCE TO RELATED APPLICATIONS

This application claims priority to and the benefit of Korean Patent Application No. 10-2024-0163044 filed in the Korean Intellectual Property Office on Nov. 15, 2024, the entire contents of which is incorporated herein by reference.

### TECHNICAL FIELD

The present disclosure relates to an apparatus and method for predicting a delivery time and a delivery path based on crowd estimation. More particularly, the present disclosure relates to an apparatus and method for predicting a delivery time and a delivery path based on crowd estimation, in an indoor robot delivery service.

### BACKGROUND

For outdoor deliveries, there are different variables involved in predicting indoor unmanned delivery times, such as road conditions and driver behavior. In the case of indoor robot delivery, it is good to predict the travel time between floors by identifying the elevator stop/load change, but there is a problem that it does not consider whether the robot can board depending on the congestion level.

In particular, in the case that the delivery robot uses the same the same as elevator or entry-and-exit door with people, depending on the traffic, it may not be impossible for the robot to be boarded on the elevator or to pass through the entry-and-exit door at the required time.

### SUMMARY

The present disclosure attempts to provide, for the indoor robot delivery service, an apparatus and method for predicting a delivery time and a delivery path based on crowd estimation capable of, by using an elevator, an entry-and-exit gate, a CCTV, or the like, calculating a traffic and a latency by counting the number of persons or the number of objects on the robot movement path and identifying crowdedness of a specific section, predicting the delivery time based on the calculated traffic and latency, and determining a path of a shortest delivery time as the delivery path.

A method for predicting a delivery time and a delivery path based on crowd estimation may include setting a plurality of paths to reach a destination, collecting crowd estimation information of the plurality of paths through sensors on the plurality of paths, calculating a traffic and a latency for each of the plurality of paths based on the crowd estimation information, predicting the delivery time to the destination based on the traffic and the latency with respect to each of the plurality of paths, and determining the delivery path as a path of a shortest delivery time among the plurality of paths.

The setting the plurality of paths to reach the destination may include receiving a stored movement path plan from robot when a delivery request is received, and identifying the plurality of paths based on the movement path plan where a travel time difference to the destination between paths do not exceed threshold level.

The sensor may include a camera sensor including a CCTV, a lidar sensor, a thermal imaging sensor, an elevator sensor, a robot sensor, and an entry-and-exit gate sensor.

The collecting the crowd estimation information of the plurality of paths through sensors on the plurality of paths may include collecting people counting information for each of the plurality of paths through the camera sensor and the thermal imaging sensor.

The collecting the crowd estimation information of the plurality of paths through sensors on the plurality of paths may include collecting crowdedness of a specific section including an elevator section and an entry-and-exit gate section on the paths based on entry and exit log data obtained from the elevator sensor and the entry-and-exit gate sensor.

The calculating the traffic and the latency for each of the plurality of paths based on the crowd estimation information may include calculating the traffic based on the people counting information and crowdedness of the specific section and storing the calculated traffic in a database.

The calculating the traffic and the latency for each of the plurality of paths based on the crowd estimation information may include calculating the latency based on a time between a time point collecting the crowd estimation information and a time point of calculating the traffic by using the crowd estimation information.

The predicting the delivery time to the destination based on the traffic and the latency with respect to each of the plurality of paths may include predicting the delivery time with respect to each of for each of the plurality of paths, by adding a required time calculated based on the traffic and a delay time calculated according to the latency.

The method may further include comparing the predicted delivery time and an actual delivery time with respect to the finally determined delivery path, after the delivery is completed, and updating a delivery time prediction model based on the comparison result when the comparison result satisfies a specific criterion, and storing the comparison result in a database when the comparison result does not satisfy the specific criterion.

When the traffic and the latency cannot be calculated due to a defect or error of the sensor, the predicting the delivery time to the destination based on the traffic and the latency with respect to each of the plurality of paths may further include predicting an average delivery time based on recent traffic information including crowdedness and people counting information during a recent specific period stored in the database, and recent average latency information, and the determining the delivery path as the path of the shortest delivery time among the plurality of paths may include generating a plurality of delivery paths and set priorities based on the average delivery time, and determining an initial delivery path as a first path having a highest priority, and finally determining the delivery path as a second path having a subsequent priority based on the traffic and latency information updated while performing delivery.

An apparatus for predicting a delivery time and a delivery path based on crowd estimation may include a data analyzer configured to collect crowd estimation information to a destination with respect to a plurality of paths through a sensor, a path analyzer configured to calculate traffic and latency to the destination with respect to each of the plurality of paths based on the crowd estimation information, a delivery time prediction unit configured to predict the delivery time to the destination based on the traffic and the latency with respect to each of the plurality of paths, and a delivery path determining unit configure to determine the delivery path as a path of a shortest delivery time among the plurality of paths.

When a delivery request is received, the data analyzer may be configured to receive a stored movement path plan from robot, and to identify the plurality of paths based on the movement path plan where a travel time difference to the destination between paths do not exceed a threshold level.

The sensor may include a camera sensor including a CCTV, a lidar sensor, a thermal imaging sensor, an elevator sensor, robot sensor and an entry-and-exit gate sensor.

The data analyzer may be configured to collect people counting information for each of the plurality of paths through the camera sensor and the thermal imaging sensor.

The data analyzer may be configured to collect crowdedness of a specific section including an elevator section and an entry-and-exit gate section on the paths based on entry and exit log data obtained from the elevator sensor and the entry-and-exit gate sensor.

The path analyzer may be configured to calculate the traffic based on the people counting information and crowdedness of the specific section and store the calculated traffic in a database.

The path analyzer may be configured to calculate the latency based on a time between a time point collecting the crowd estimation information and a time point of calculating the traffic by using the crowd estimation information.

The delivery time prediction unit may be configured to predict the delivery time with respect to each of for each of the plurality of paths, by adding a required time calculated based on the traffic and a delay time calculated according to the latency.

The apparatus may further include a training unit configured to, after the delivery is completed, compare the predicted delivery time and an actual delivery time with respect to the finally determined delivery path, update a delivery time prediction model based on the comparison result when the comparison result satisfies a specific criterion, and store the comparison result in a database when the comparison result does not satisfy the specific criterion.

When the traffic and the latency cannot be calculated due to a defect or error of the sensor, the delivery time prediction unit may be configured to predict an average delivery time based on recent traffic information including crowdedness and people counting information during a recent specific period stored in a database, and recent average latency information, and the delivery path determining unit may be configured to: generate a plurality of delivery paths and set priorities based on the predicted average delivery time, determine an initial delivery path as a first path having a highest priority, and finally determine the delivery path as a second path having a subsequent priority based on the traffic and latency information updated while performing delivery.

An apparatus and method for predicting a delivery time and a delivery path based on crowd estimation according to an embodiment is for the indoor robot delivery service, and is capable of, by using an elevator, an entry-and-exit gate, a CCTV, or the like, calculating a traffic and a latency by counting the number of persons or the number of objects on the robot movement path and identifying crowdedness of a specific section, predicting the delivery time based on the calculated traffic and latency, and determining a path of a shortest delivery time as the delivery path.

### BRIEF DESCRIPTION OF THE DRAWINGS

FIG. 1 schematically shows a system for predicting a delivery time and a delivery path based on crowd estimation according to an embodiment.

FIG. 2 and FIG. 3 are block diagrams of an apparatus for predicting a delivery time and a delivery path based on crowd estimation according to an embodiment.

FIG. 4 to FIG. 6 are flowcharts of a method for predicting a delivery time and a delivery path based on crowd estimation according to an embodiment.

FIG. 7 is a drawing for explaining a method for predicting a delivery time and a delivery path based on crowd estimation according to an embodiment.

FIG. 8 is a drawing for explaining a computing device according to an embodiment.

### DETAILED DESCRIPTION OF ILLUSTRATIVE EMBODIMENTS

An embodiment of the disclosure will be described more fully hereinafter with reference to the accompanying drawings such that a person skill in the art may easily implement the embodiment. As those skilled in the art would realize, the described embodiments may be modified in various different ways, all without departing from the spirit or scope of the present disclosure. In order to clarify the present disclosure, parts that are not related to the description will be omitted, and the same elements or equivalents are referred to with the same reference numerals throughout the specification.

In addition, unless explicitly described to the contrary, the word “comprise” and variations such as “comprises” or “comprising” will be understood to imply the inclusion of stated elements but not the exclusion of any other elements. Terms including an ordinary number, such as first and second, are used for describing various constituent elements, but the constituent elements are not limited by the terms. The terms are only used to differentiate one component from other components.

In addition, the terms “unit”, “part” or “portion”, “-er”, and “module” in the specification refer to a unit that processes at least one function or operation, which may be implemented by hardware, software, or a combination of hardware and software.

Hereinafter, embodiments of the present disclosure will be described with reference to the drawings.

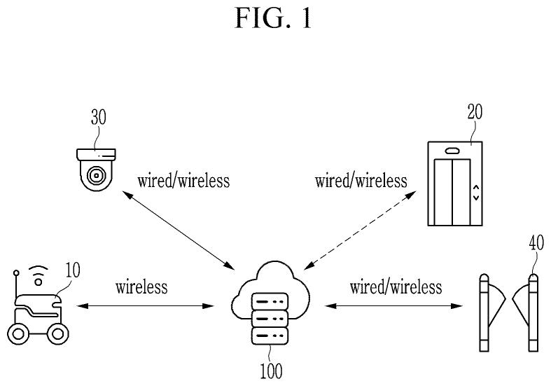

FIG. 1 schematically shows a system for predicting a delivery time and a delivery path based on crowd estimation according to an embodiment.

Referring to FIG. 1, a system for predicting a delivery time and a delivery path based on crowd estimation may include an apparatus 100 for predicting a delivery time and a delivery path based on crowd estimation, a delivery robot 10, an elevator 20, a CCTV 30 and an entry-and-exit gate 40.

The apparatus 100 for predicting a delivery time and a delivery path based on crowd estimation, the delivery robot 10, the elevator 20, the CCTV 30 and the entry-and-exit gate 40 may be connected to each other through a wired/wireless network.

The apparatus 100 for predicting a delivery time and a delivery path based on crowd estimation predict a delivery time of the delivery robot 10 based on crowd estimation information including people counting information and crowdedness information, and may generate an optimal delivery path based on the predicted robot delivery time.

The delivery robot 10 may be implemented as a robot that performs an unmanned delivery within a specific space including an interior of a building.

The delivery robot 10 may move inside the building according to a stored movement path plan.

The delivery robot 10 may include various types of robot sensors such as a camera, a lidar, or the like.

A plurality of elevators 20 may exist on the delivery path within the building. The elevator 20 may include various elevator sensors including a camera sensor, a thermal imaging sensor, a door opening/closing sensor, and a weight sensor.

A plurality of CCTVs 30 may exist on the delivery path within the building. The CCTV 30 may include a camera sensor and a thermal imaging sensor.

A plurality of entry-and-exit gates 40 may exist on the delivery path within the building. The entry-and-exit gate 40 may include various sensors, and sense persons or objects passing through it and count the number thereof.

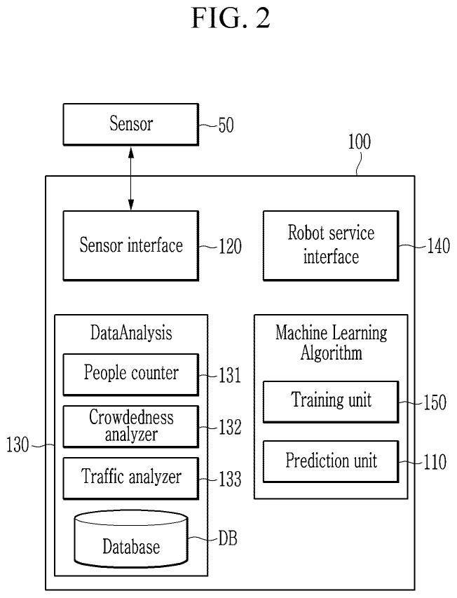

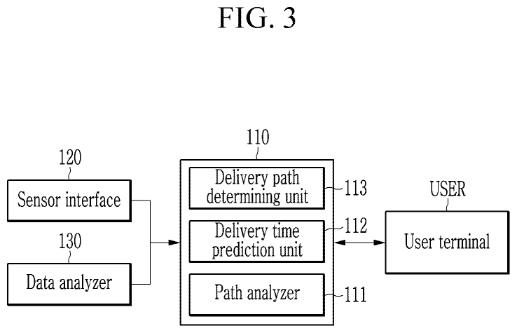

FIG. 2 and FIG. 3 are block diagrams of an apparatus for predicting a delivery time and a delivery path based on crowd estimation according to an embodiment.

Referring to FIG. 2 and FIG. 3, the apparatus 100 for predicting a delivery time and a delivery path based on crowd estimation may include a prediction unit 110, a sensor interface 120, data analyzer 130, a robot service interface 140 and a training unit 150.

The apparatus 100 for predicting a delivery time and a delivery path based on crowd estimation may be connected to the various sensors 50 including a camera sensor, a thermal imaging sensor, a lidar sensor, an elevator sensor, a robot sensor, and an entry-and-exit gate sensor installed in the delivery robot 10, the elevator 20, the CCTV 30, and the entry-and-exit gate 40 of FIG. 1 through the sensor interface 120.

The prediction unit 110 may receive the crowd estimation information from the sensor interface 120 and the data analyzer 130, and may predict the delivery time based on a traffic and a latency calculated based on the received crowd estimation information.

The prediction unit 110 may determine the optimal delivery path from among a plurality of robot delivery paths based on the predicted delivery time.

The prediction unit 110 may estimate the delivery time and the delivery path by using an artificial intelligence prediction model trained according to the repeated delivery time prediction and delivery path determination.

In an embodiment, when a delivery request is received, the data analyzer 130 may receive the stored movement path plan from the delivery robot.

The data analyzer 130 may identify a plurality of paths based on the movement path plan where a travel time difference between paths to the destination do not exceed a threshold level.

The data analyzer 130 may collect the crowd estimation information to the destination with respect to the plurality of paths through sensors. The crowd estimation information may include a congestion level of a specific environment calculated through a camera and sensor. The crowd estimation information may be calculated based on the number of persons and crowdedness of a specific environment.

The data analyzer 130 may include a people counter 131, a crowdedness analyzer 132 and the traffic analyzer 133.

The people counter 131 may collect the people counting information for each of the plurality of paths through a camera sensor, a lidar sensor, and a thermal imaging sensor. The people counting information may include the number of persons within the specific space identified through a camera sensor, or the like.

The crowdedness analyzer 132 may calculate crowdedness of each of the plurality of paths based on the people counting information. The more persons on the path, the greater the crowdedness may be.

The crowdedness analyzer 132 may collect crowdedness of a specific section including the elevator section and the entry-and-exit gate section on the paths based on entry and exit log data obtained from the elevator sensor and the entry-and-exit gate sensor.

Each of the plurality of paths may include a plurality of specific sections. The crowdedness analyzer 132 may calculate the crowdedness of corresponding sections based on real-time records of entry and exit of the elevator and/or the entry-and-exit gate. That is, the more records of entry and exit there are, the greater the crowdedness may be.

For example, when the records of entry and exit increases within a designated preset time, the crowdedness analyzer 132 may determine the crowdedness of the corresponding section to be greater than those of other sections.

For example, when a speed gate for the disabled among the entry-and-exit gates is opened or when any one entry-and-exit gate is open for a long time, the crowdedness analyzer 132 may determine that a large object or a majority of persons have entered or exited the section or region at the same time.

The traffic analyzer 133 may calculate the traffic based on the people counting information and the crowdedness of the specific section and store the calculated traffic in a database DB.

The traffic may be proportional to the number of persons and crowdedness on the path. The traffic is calculated for each of the plurality of paths, and the predicted delivery time for a path having low traffic is smaller than the predicted delivery time for a path having high traffic.

The traffic may include rating information calculated based on the people counting information and crowdedness. The rating information may relatively represent the size of the traffic between the paths.

The traffic analyzer 133 may determine whether passing through the elevator or the entry-and-exit door on the movement path is possible at the delivery time point, based on the number of persons and crowdedness.

That is, based on the crowd estimation information, the traffic analyzer 133 may detect an excessive traffic situation or the like in which the robot cannot use the elevator or the entry-and-exit gate due to a specific event or crowding phenomenon on the path.

The prediction unit 110 may include a path analyzer 111, a delivery time prediction unit 112 and a delivery path determining unit 113.

The path analyzer 111 may calculate the traffic and the latency to the destination with respect to each of the plurality of paths based on the crowd estimation information.

The path analyzer 111 may calculate the latency based on a time between a time point collecting the crowd estimation information and a time point of calculating the traffic by using the crowd estimation information.

The latency may be a factor that delays the predicted delivery time of the robot delivery.

The delivery time prediction unit 112 may predict the delivery time to the destination based on the traffic and the latency with respect to each of the plurality of paths.

With respect to each of the plurality of paths, the delivery time prediction unit 112 may predict the delivery time by adding a required time calculated based on the traffic and a delay time calculated according to the latency.

When the traffic and the latency cannot be calculated due to a defect or error of the sensor, the delivery time prediction unit 112 may predict an average delivery time for that path based on recent traffic information including crowdedness and the people counting information during a recent specific period stored in the database DB, and recent average latency information.

The delivery path determining unit 113 may determine a path with a shortest predicted delivery time among the plurality of paths as the delivery path.

When the traffic and the latency cannot be calculated due to a defect or error of the sensor, the delivery path determining unit 113 may generate a plurality of delivery paths based on the predicted average delivery time, and may set priorities between the delivery paths.

The delivery path determining unit 113 may determine an initial delivery path as a first path having a highest priority, and may finally determine the delivery path as a second path having a subsequent priority based on the traffic and latency information updated in real time while the robot performs the delivery.

That is, the delivery path determining unit 113 may first exclude paths with long recent average delivery times from the delivery paths. The delivery path determining unit 113 may initially determine the first path, and when the delivery time of the first path increases by a threshold reference or more according to the traffic and the latency in real-time before or while the robot delivery is in progress, may change the delivery path to the second path.

The prediction unit 110 may provide information on the predicted delivery time and delivery path to the user through a user application or web page of a user terminal USER.

The robot service interface 140 may transmit and request data for a robot delivery service to and from a robot control server. For example, the robot service interface 140 may request product order details, estimated cooking and preparation time.

The robot service interface 140 may provide various information related to orders and deliveries to the prediction unit 110.

The robot service interface 140 may provide an initial estimated delivery time based on delivery information such as order details and preparation time.

The robot service interface 140 may provide the training unit 150 with various information for training the prediction model.

After the delivery is completed, the training unit 150 may compare the predicted delivery time with respect to the finally determined delivery path and an actual delivery time, update the delivery time prediction model based on the comparison result when the comparison result satisfies a specific criterion, and store the comparison result in the database DB when the comparison result does not satisfy the specific criterion.

The database DB may store analyzed data with respect to the crowdedness and the traffic. The database DB may store data for the predicted delivery time and the determined delivery path according to order information.

The database DB may provide the stored data to the training unit 150, and the training unit 150 may in real time by using the provided data update the prediction model.

The database DB may be separately provided without being disposed on the data analyzer 130.

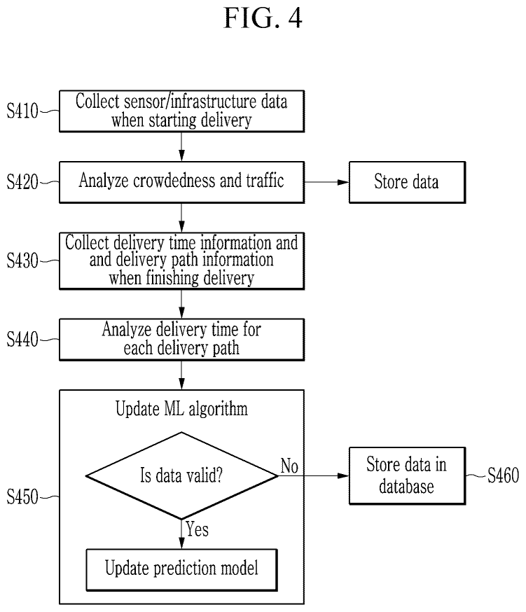

FIG. 4 to FIG. 6 are flowcharts of a method for predicting the delivery time and the delivery path based on crowd estimation according to an embodiment.

The method for predicting the delivery time and the delivery path based on crowd estimation of FIG. 4 to FIG. 6 may be performed by using the apparatus 100 for predicting the delivery time and the delivery path based on crowd estimation of FIG. 1.

FIG. 4 is a flowchart showing a process of training the prediction model according to an embodiment.

In FIG. 4, at step S410, the apparatus 100 for predicting the delivery time and the delivery path based on crowd estimation may collect sensor data and infrastructure data when starting the delivery.

The apparatus 100 for predicting the delivery time and the delivery path based on crowd estimation may collect the order information, the sensor data on a robot movement path, and the infrastructure data through the sensor interface 120 and the robot service interface 140.

At step S420, the apparatus 100 for predicting the delivery time and the delivery path based on crowd estimation may analyze the crowdedness and the traffic on the movement path. The people counting information, the crowdedness, and the traffic may be stored in the database in real-time.

At step S430, when the delivery according to the delivery path extracted based on the traffic is finished, the apparatus 100 for predicting the delivery time and the delivery path based on crowd estimation may collect the delivery time information and the delivery path information.

At step S440, the apparatus 100 for predicting the delivery time and the delivery path based on crowd estimation may analyze the delivery time for each delivery path.

At step S450, the apparatus 100 for predicting the delivery time and the delivery path based on crowd estimation may train and update the prediction model based on the analysis data.

When validity of analysis data is considered and the data is determined to be valid, the apparatus 100 for predicting the delivery time and the delivery path based on crowd estimation may update the prediction model based on the corresponding data.

The apparatus 100 for predicting the delivery time and the delivery path based on crowd estimation may compare the predicted delivery time and the actual delivery time, and may determine validity of data according to whether the difference is below predetermined level.

Alternatively, when the predicted delivery path and/or delivery time has an abnormal value that exceeds a general (predetermined) level, the apparatus 100 for predicting the delivery time and the delivery path based on crowd estimation may determine it to be not valid.

At step S460, when the data is not valid, the apparatus 100 for predicting the delivery time and the delivery path based on crowd estimation stores it in the database. The data stored in the database may be later used for training the prediction model or providing information.

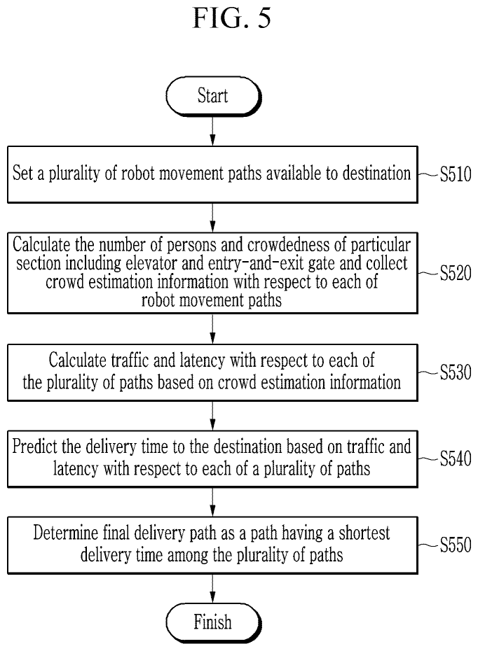

In FIG. 5, at step S510, the apparatus 100 for predicting the delivery time and the delivery path based on crowd estimation may set a plurality of robot movement paths available to the destination.

When the delivery request is received, the apparatus 100 for predicting the delivery time and the delivery path based on crowd estimation may receive the stored movement path plan from the robot, and may identify the plurality of paths based on the movement path plan where a travel time difference between paths to the destination do not exceed the threshold level.

At step S520, the apparatus 100 for predicting the delivery time and the delivery path based on crowd estimation may calculate the number of persons and crowdedness of the specific section including the elevator and the entry-and-exit gate, and may collect the crowd estimation information with respect to each of the robot movement paths.

The apparatus 100 for predicting the delivery time and the delivery path based on crowd estimation may collect the people counting information for each of the plurality of paths through a camera sensor and a thermal imaging sensor.

The apparatus 100 for predicting the delivery time and the delivery path based on crowd estimation may collect crowdedness of the specific section including the elevator section and the entry-and-exit gate section on the paths based on the entry and exit log data obtained from the elevator sensor and the entry-and-exit gate sensor.

At step S530, the apparatus 100 for predicting the delivery time and the delivery path based on crowd estimation may calculate the traffic and the latency for each of the plurality of paths based on the crowd estimation information.

The apparatus 100 for predicting the delivery time and the delivery path based on crowd estimation may calculate the traffic based on the people counting information and the crowdedness of the specific section and store the calculated traffic in the database.

The apparatus 100 for predicting the delivery time and the delivery path based on crowd estimation may calculate the latency based on the time between the time point collecting the crowd estimation information and the time point of calculating the traffic by using the crowd estimation information.

At step S540, the apparatus 100 for predicting the delivery time and the delivery path based on crowd estimation may predict the delivery time to the destination based on the traffic and the latency with respect to each of the plurality of paths.

The apparatus 100 for predicting the delivery time and the delivery path based on crowd estimation may predict the delivery time with respect to each of for each of the plurality of paths, by adding the required time calculated based on the traffic and the delay time calculated according to the latency.

At step S550, the apparatus 100 for predicting the delivery time and the delivery path based on crowd estimation may determine a path with a shortest delivery time among the plurality of paths as a final delivery path.

After the delivery is completed, the apparatus 100 for predicting the delivery time and the delivery path based on crowd estimation may compare the predicted delivery time with respect to the finally determined delivery path and the actual delivery time, and when the comparison result satisfies the specific criterion, may update the delivery time prediction model based on the comparison result.

When the comparison result does not satisfy the specific criterion, the apparatus 100 for predicting the delivery time and the delivery path based on crowd estimation may store the comparison result in the database.

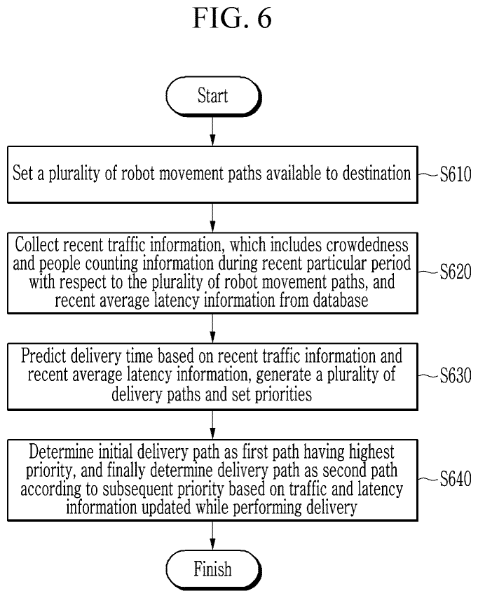

FIG. 6 is a flowchart showing a method for predicting the delivery time and the delivery path based on crowd estimation according to an embodiment when the traffic and the latency cannot be calculated due to a defect or error of the sensor.

In FIG. 6, at step S610, the apparatus 100 for predicting the delivery time and the delivery path based on crowd estimation may set the plurality of robot movement paths available to the destination.

At step S620, the apparatus 100 for predicting the delivery time and the delivery path based on crowd estimation may collect the recent traffic information including crowdedness and the people counting information during the recent specific period with respect to the plurality of robot movement paths, and the recent average latency information from the database.

At step S630, the apparatus 100 for predicting the delivery time and the delivery path based on crowd estimation may predict the delivery time based on the recent traffic information and the recent average latency information, to generate the plurality of delivery paths and set priorities.

At step S640, the apparatus 100 for predicting the delivery time and the delivery path based on crowd estimation may determine the initial delivery path as the first path having a highest priority, and may finally determine the delivery path as the second path according to a subsequent priority, based on the traffic and latency information updated while performing delivery.

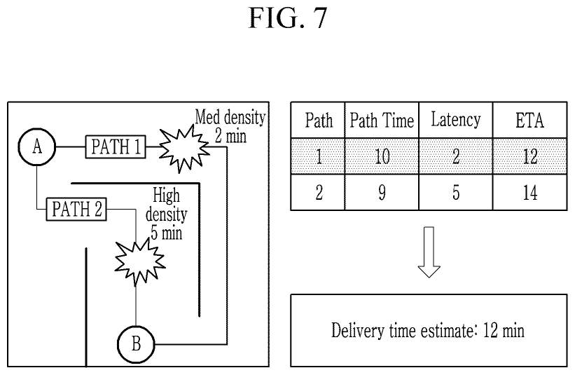

FIG. 7 is a drawing for explaining a method for predicting the delivery time and the delivery path based on crowd estimation according to an embodiment.

In FIG. 7, the delivery path available from an origin A to a destination B has a first delivery path PATH1 and a second delivery path PATH2.

The predicted delivery time ETA through the first delivery path PATH1 may be 12 minutes in consideration of both the traffic 10 minutes and a latency 2 minutes. In comparison, the predicted delivery time through the second delivery path PATH2 may be 14 minutes.

The apparatus 100 for predicting the delivery time and the delivery path based on crowd estimation may finally determine the first delivery path PATH1 of which the traffic identified based on crowdedness and the delivery time predicted based on the latency are shorter.

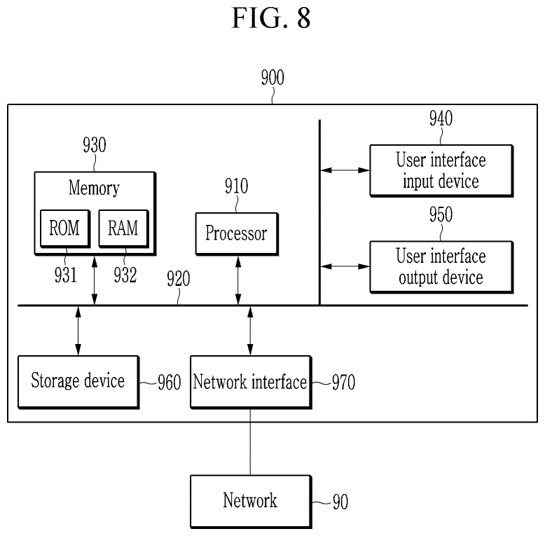

FIG. 8 is a drawing for explaining a computing device according to an embodiment.

Referring to FIG. 8, an apparatus and method for predicting robot the delivery time and robot delivery path based on crowd estimation according to embodiments may be implemented by using a computing device 900.

The computing device 900 may include at least one of a processor 910, a memory 930, the user interface input device 940, the user interface output device 950 and a storage device 960 that communicate through a bus 920. The computing device 900 may also include a network interface 970 electrically connected to a network 90. The network interface 970 may transmit or receive signals with other entities through the network 90.

The processor 910 may be implemented in various types such as a micro controller unit (MCU), an application processor (AP), a central processing unit (CPU), a graphic processing unit (GPU), a neural processing unit (NPU), and the like, and may be any type of semiconductor device capable of executing instructions stored in the memory 930 or the storage device 960. The processor 910 may be configured to implement the functions and methods described above with respect to FIG. 1 to FIG. 7.

The memory 930 and the storage device 960 may include various types of volatile or non-volatile storage media. For example, the memory may include read-only memory (ROM) 931 and a random-access memory (RAM) 932. In this embodiment, the memory 930 may be located inside or outside processor 910, and the memory 930 may be connected to the processor 910 through various known means.

In some embodiments, at least some configurations or functions of an apparatus and method for predicting a robot the delivery time and a robot delivery path based on crowd estimation according to an embodiment may be implemented as a program or software executable by the computing device 900, and program or software may be stored in a computer-readable medium.

In some embodiments, at least some configurations or functions of an apparatus and method for predicting a robot the delivery time and a robot delivery path based on crowd estimation according to an embodiment may be implemented by using hardware or circuitry of the computing device 900, or may also be implemented as separate hardware or circuitry that may be electrically connected to the computing device 900.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

100: apparatus for predicting the delivery time and the delivery path based on crowd estimation
110: prediction unit
120: sensor interface
130: data analyzer
140: robot service interface
150: training unit

What is claimed is:

1. A method for predicting a delivery time and a delivery path based on crowd estimation, the method comprising:
setting a plurality of paths to reach a destination;
collecting crowd estimation information of the plurality of paths through sensors on the plurality of paths;
calculating a traffic and a latency for each of the plurality of paths based on the crowd estimation information;
predicting the delivery time to the destination based on the traffic and the latency with respect to each of the plurality of paths; and
determining the delivery path as a path of a shortest delivery time among the plurality of paths.

2. The method of claim 1, wherein the setting the plurality of paths to reach the destination comprises receiving a stored movement path plan from robot when a delivery request is received, and identifying the plurality of paths based on the movement path plan where a travel time difference to the destination between paths do not exceed a threshold level.

3. The method of claim 1, wherein the sensors comprise a camera sensor comprising a CCTV, a lidar sensor, a thermal imaging sensor, an elevator sensor, a robot sensor, and an entry-and-exit gate sensor.

4. The method of claim 3, wherein the collecting the crowd estimation information of the plurality of paths through sensors on the plurality of paths comprises:
collecting people counting information for each of the plurality of paths through the camera sensor and the thermal imaging sensor.

5. The method of claim 4, wherein the collecting the crowd estimation information of the plurality of paths through sensors on the plurality of paths comprises:
collecting crowdedness of a specific section comprising an elevator section and an entry-and-exit gate section on the paths based on entry and exit log data obtained from the elevator sensor and the entry-and-exit gate sensor.

6. The method of claim 5, wherein the calculating the traffic and the latency for each of the plurality of paths based on the crowd estimation information comprises:
calculating the traffic based on the people counting information and crowdedness of the specific section and storing the calculated traffic in a database.

7. The method of claim 6, wherein, when the traffic and the latency cannot be calculated due to a defect or error of the sensor,
the predicting the delivery time to the destination based on the traffic and the latency with respect to each of the plurality of paths further comprises predicting an average delivery time based on recent traffic information comprising crowdedness and people counting information during a recent specific period stored in the database, and recent average latency information, and
the determining the delivery path as the path of the shortest delivery time among the plurality of paths comprises:
generating a plurality of delivery paths and set priorities based on the average delivery time; and
determining an initial delivery path as a first path having a highest priority, and finally determining the delivery path as a second path having a subsequent priority based on the traffic and latency information updated while performing delivery.

8. The method of claim 1, wherein the calculating the traffic and the latency for each of the plurality of paths based on the crowd estimation information comprises:
calculating the latency based on a time between a time point collecting the crowd estimation information and a time point of calculating the traffic by using the crowd estimation information.

9. The method of claim 1, wherein the predicting the delivery time to the destination based on the traffic and the latency with respect to each of the plurality of paths comprises:
predicting the delivery time with respect to each of for each of the plurality of paths, by adding a required time calculated based on the traffic and a delay time calculated according to the latency.

10. The method of claim 1, further comprising:
comparing the predicted delivery time and an actual delivery time with respect to the determined delivery path, after a delivery is completed, and updating a delivery time prediction model based on a comparison result of the comparing when the comparison result satisfies a specific criterion; and
storing the comparison result in a database when the comparison result does not satisfy the specific criterion.

11. An apparatus for predicting a delivery time and a delivery path based on crowd estimation, comprising:
a data analyzer configured to collect crowd estimation information to a destination with respect to a plurality of paths through a sensor;
a path analyzer configured to calculate traffic and latency to the destination with respect to each of the plurality of paths based on the crowd estimation information;
a delivery time prediction unit configured to predict the delivery time to the destination based on the traffic and the latency with respect to each of the plurality of paths; and
a delivery path determining unit configure to determine the delivery path as a path of a shortest delivery time among the plurality of paths.

12. The apparatus of claim 11, wherein, when a delivery request is received, the data analyzer is configured to receive a stored movement path plan from robot, and to identify the plurality of paths based on the movement path plan where a travel time difference to the destination between paths do not exceed a threshold level.

13. The apparatus of claim 11, wherein the sensor comprises a camera sensor comprising a CCTV, a lidar sensor, a thermal imaging sensor, an elevator sensor, robot sensor and an entry-and-exit gate sensor.

14. The apparatus of claim 13, wherein the data analyzer is configured to collect people counting information for each of the plurality of paths through the camera sensor and the thermal imaging sensor.

15. The apparatus of claim 14, wherein the data analyzer is configured to collect crowdedness of a specific section comprising an elevator section and an entry-and-exit gate section on the paths based on entry and exit log data obtained from the elevator sensor and the entry-and-exit gate sensor.

16. The apparatus of claim 15, wherein the path analyzer is configured to calculate the traffic based on the people counting information and crowdedness of the specific section and store the calculated traffic in a database.

17. The apparatus of claim 11, wherein the path analyzer is configured to calculate the latency based on a time between a time point collecting the crowd estimation information and a time point of calculating the traffic by using the crowd estimation information.

18. The apparatus of claim 11, wherein the delivery time prediction unit is configured to predict the delivery time with respect to each of for each of the plurality of paths, by adding a required time calculated based on the traffic and a delay time calculated according to the latency.

19. The apparatus of claim 11, further comprising a training unit configured to, after the delivery is completed, compare the predicted delivery time and an actual delivery time with respect to the finally determined delivery path, update a delivery time prediction model based on the comparison result when the comparison result satisfies a specific criterion, and store the comparison result in a database when the comparison result does not satisfy the specific criterion.

20. The apparatus of claim 11, wherein, when the traffic and the latency cannot be calculated due to a defect or error of the sensor,
the delivery time prediction unit is configured to predict an average delivery time based on recent traffic information comprising crowdedness and people counting information during a recent specific period stored in a database, and recent average latency information, and
the delivery path determining unit is configured to:
generate a plurality of delivery paths and set priorities based on the predicted average delivery time;
determine an initial delivery path as a first path having a highest priority, and finally determine the delivery path as a second path having a subsequent priority based on the traffic and latency information updated while performing delivery.
